(19) United States
(12) Patent Application Publication
(10) Pub. No.: US 2008/0038085 A1
(43) Pub. Date: Feb. 14, 2008

(54) RIVET SETTING DEVICE FOR SETTING SELF-TAPPING RIVETS

(75) Inventor: A.L. PEPPER AASGAARD, OMAHA, NE (US)

Correspondence Address: MCKEE, VOORHEES & SEASE, P.L.C., 801 GRAND AVENUE, SUITE 3200, DES MOINES, IA, 50309-2721, US

(73) Assignee: ABEO, LLC, Omaha, NE (US)

(21) Appl. No.: 11/748,929

(22) Filed: May 15, 2007

Related U.S. Application Data
(60) Provisional application No. 60/800,528, filed on May 15, 2006.

(51) Int. Cl. F16B 33/06

(52) U.S. Cl. 411/378; 411/390

(57) ABSTRACT

A rivet setting device for setting a self-tapping rivet in a work piece includes a rotatable head for rotating a self-tapping rivet to form a hole in the work piece and a shank retracting assembly for compressing and spreading the hollow body of the self-tapping rivet, allowing the head of the self-tapping rivet to detach from the shank upon application of a predetermined tensile force. The rotatable head comprises a clutch having a body enclosing a plurality of bearings circumferentially located around the shank, for gripping the shank. The clutch is formed with a plurality of tapered channels for urging the bearings into engagement with the shank upon rotation of the clutch.

### CROSS-REFERENCE TO RELATED APPLICATIONS

This application claims priority under 35 U.S.C. §119 to provisional application Serial No. 60/800,528 filed May 15, 2006, herein incorporated by reference in its entirety.

The following related and commonly owned patents are incorporated herein by reference in their entirety: U.S. Pat. No. 5,741,099 issued Apr. 21, 1998; U.S. Pat. No. 5,762,456, issued Jun. 9, 1998; U.S. Pat. No. 5,915,901, issued Jun. 29, 1999; U.S. Pat. No. 6,796,759, issued Sep. 28, 2004; and, U.S. Ser. No. 11/740,101, titled

### FIELD OF THE INVENTION

The present invention generally relates to the field of tools and devices for setting rivets, and more particularly to a rivet setting device suitable for setting self-tapping rivets.

### BACKGROUND OF THE INVENTION

Blind setting rivets are usually set in a work piece using a rivet setting tool or device which may be pneumatically, electrically, or hydraulically powered. Blind setting rivets typically include a hollow rivet body and a mandrel disposed longitudinally within the hollow rivet body. The mandrel includes a shank terminating in a head for radially compressing and spreading the rivet body as the mandrel is retracted rearward relative to the rivet body. The shank includes an area of reduced diameter for allowing the head to detach from the shank upon application of a predetermined tensile force applied to the shank. To set a blind setting rivet, the shank of the rivet mandrel is inserted into the rivet setting tool. The tubular portion of the hollow rivet body is inserted though a hole formed in the workpiece and the rivet setting device is activated, retracting the shank rearward relative to the rivet body causing the head to compress and spread the rivet body to set the rivet. The shank then separates from the head at the area of reduced diameter and is discarded.

Self-tapping, blind setting rivets, as described in U.S. Pat. Nos. 5,741,099, 5,762,456, 5,915,901 6,796,759, and, U.S. Ser. No. 11/740,101, titled SELF-POLISHING AND TAPPING RIVET ASSEMBLY, filed Apr. 25, 2007, include a self-tapping head that taps a hole in the work piece. In this manner, a separate hole-drilling step may be eliminated when applying the rivet. However, because conventional rivet setting tools do not rotate the mandrel of the rivet, application of such self-tapping rivets currently requires the use of a drill for rotating the rivet mandrel to tap a hole in the workpiece. The rivet setting device may then be used setting the rivet in the work piece and detaching the shank from the rivet. This use of two separate tools slows application of the rivets, reducing their advantage over non-tapping varieties.

Consequently, it would be advantageous to provide a rivet setting device suitable for setting self-tapping rivets. The rivet setting device should be capable of gripping and turning the mandrel of the rivet in order to turn the self-tapping head of the rivet for tapping a hole in the workpiece

### BRIEF SUMMARY OF THE INVENTION

The present invention is directed to a rivet setting device for setting a self-tapping rivet in a work piece. The rivet setting device includes a rotatable head for rotating a self-tapping rivet to form a hole in the work piece, and a shank retracting assembly for compressing and spreading the hollow body of the self-tapping rivet, allowing the head of the self-tapping rivet to detach from the shank upon application of a predetermined tensile force.

In one specific embodiment, the rotatable head comprises a clutch including a clutch body enclosing a plurality of bearings circumferentially located around the shank, for gripping the shank. In this embodiment, the clutch body is formed with a plurality of tapered channels for urging or forcing the bearings into engagement with the shank upon rotation of the clutch. A magnet and magnetic cover is located behind the front cover for retaining the shank in the rotatable head prior to the bearing engagement of the shank.

In another specific embodiment, the rotatable head comprises a clutch including a clutch body enclosing a plurality of cylindrical rollers, one end of the cylindrical rollers having a dome shape, circumferentially located around the shank for gripping the shank. In this embodiment, the clutch body is formed with a plurality of tapered channels for urging or forcing the cylindrical rollers into engagement with the shank upon rotation of the clutch.

It is to be understood that both the foregoing general description and the following detailed description are exemplary and explanatory only and are not necessarily restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is a partial cross-sectional side elevational view illustrating a rivet setting device in accordance with an exemplary embodiment of the present invention;

FIG. 2 is cross-sectional side elevational views illustrating the rivet setting device shown in FIG. 1, wherein a self-tapping rivet is loaded in the rivet setting device;

FIG. 3 is a cross-sectional side elevational views illustrating the rivet setting device shown in FIG. 1, wherein a shank of the self-tapping rivet has been separated from a head of the self-tapping rivet;

FIGS. 4A, 4B, 4C and 4D are cross-sectional side elevational views illustrating a rotatable head and shank retracting assembly of a rivet setting device in accordance with an exemplary embodiment of the present invention;

FIG. 5 is a front elevational view illustrating the clutch of the rotatable head shown in FIGS. 4A and 4B, wherein the clutch is in a rotational position for releasing a plurality of bearings from a shank;

FIG. 6 is a front elevational view of the clutch illustrated in FIG. 5, wherein the clutch is in a rotational position for engaging a plurality of bearings with the shank, for rotating the shank;

FIG. 7 is a cross-sectional side elevational view illustrating a rotatable head, magnet and magnet cover, clutch, and bearing assembly, in accordance with an is exemplary embodiment of the present invention;

FIG. 8 is a cross-sectional side elevational view illustrating a front cover of a rotatable head, a magnet, and cylindrical bearings, in accordance with an exemplary embodiment of the present invention;

FIG. 9 is a cross-sectional front elevational view of the clutch and tapered channels, wherein the clutch is in a rotational position for engaging a plurality of bearings with the shank, for rotating the shank, and a cross-sectional side elevational view of the clutch, wherein the clutch is in a rotational position for engaging a plurality of bearings with the shank, for rotating the shank;

FIG. 10 is a cross-sectional front elevational view illustrating bearings in a tapered channel in partial advance, fully retracted, and full advance positions, located in the rotatable head shown in FIG. 7;

FIG. 11 is a cross-sectional front elevational view illustrating bearing movement in the tapered channel when the rotatable head in FIG. 7 is rotated;

FIG. 12 is a cross-sectional side elevational view illustrating a roller bin in which there are two sets of bearings, wherein the first set engages the shank when the rotatable head is rotated one way, and the second set of bearings engages the shank when the rotatable head is rotated the opposite way, in accordance with an exemplary embodiment of the present invention;

FIG. 13 is a cross-sectional front elevational view illustrating bearing movement in the tapered channel when the rotatable head in FIG. 7 is counter-rotated;

FIG. 14 is a partial cross-sectional side elevational view illustrating the roller bin in FIG. 12, in accordance with an exemplary embodiment of the present invention;

FIG. 15 is a cross-sectional side elevational view illustrating the rear cover of the rotatable head, in accordance with an exemplary embodiment of the present invention; and

FIG. 16 is a side elevational view of the rotatable head, in accordance with an exemplary embodiment of the present invention.

### DETAILED DESCRIPTION OF THE PREFERRED EMBODIMENT

Reference will now be made in detail to the presently preferred embodiments of the invention, examples of which are illustrated in the accompanying drawings.

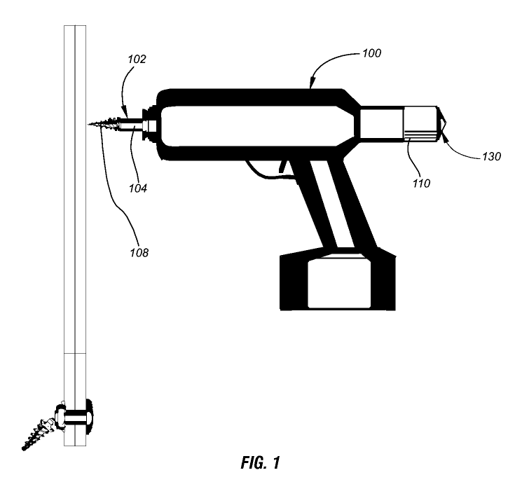

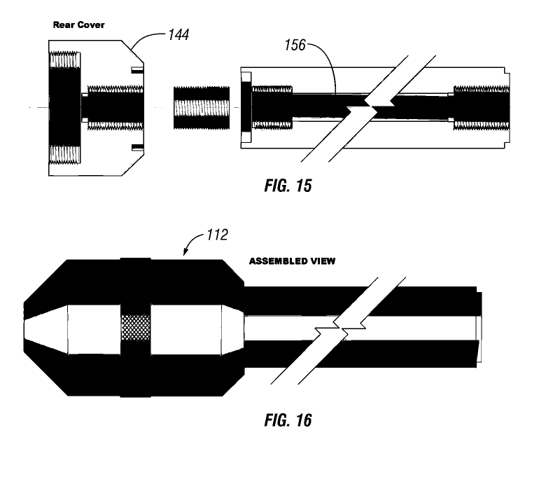

Referring generally to FIGS. 1 through 16, a rivet setting device 100 is described in accordance with an exemplary embodiment of the present invention. The rivet setting device 100 is for setting a self-tapping rivet 102 in a work piece. An exemplary self-tapping rivet 102 includes a hollow rivet body 104 and a mandrel 106 extending longitudinally through the hollow rivet body 104. The mandrel 106 includes a self-tapping head 108 for forming a hole in the work piece and a shank 110, fixedly connected to the self-tapping head 108 for rotating the self-tapping head 108 and cutting through the work piece. After the self-tapping head 108 has passed through the hole formed in the work piece, the hollow rivet body 104 is compressed and spread by the self-tapping head 108 as the mandrel 106 is retracted rearward relative to the hollow rivet body 104. The rearward tensile force is applied to the shank 110, which has an area of reduced diameter for allowing the self-tapping head 108 to detach from the shank 110 upon application of a predetermined tensile force. Preferably, the predetermined tensile force applied to the shank 110 causes separation of the self-tapping head 108 from the shank 110 upon sufficient compression and spreading of the hollow rivet body 104. Exemplary self tapping rivet assemblies suitable for use by the rivet setting device 100 of the present invention are described in U.S. Pat. No. 5,741,099, entitled Self-tapping Blind Setting Rivet Assembly, issued Apr. 21, 1998; U.S. Pat. No. 5,762,456, entitled Self-tapping Blind Setting Bolt Rivet Assembly, issued Jun. 9, 1998; and U.S. Pat. No. 5,915,901, entitled Blind Setting Rivet Assembly, issued Jun. 29, 1999; U.S. Pat. No. 6,796,759 issued Sep. 28, 2004 and entitled Self-Polishing and Tapping Rivet Assembly, and, U.S. Ser. No. 11/740,101, titled SELF-POLISHING AND TAPPING RIVET ASSEMBLY, filed Apr. 25, 2007, which are herein incorporated by reference in their entirety. The rivet setting device 100 of the present invention may also be suitable for setting conventional non self-tapping blind setting rivet assemblies.

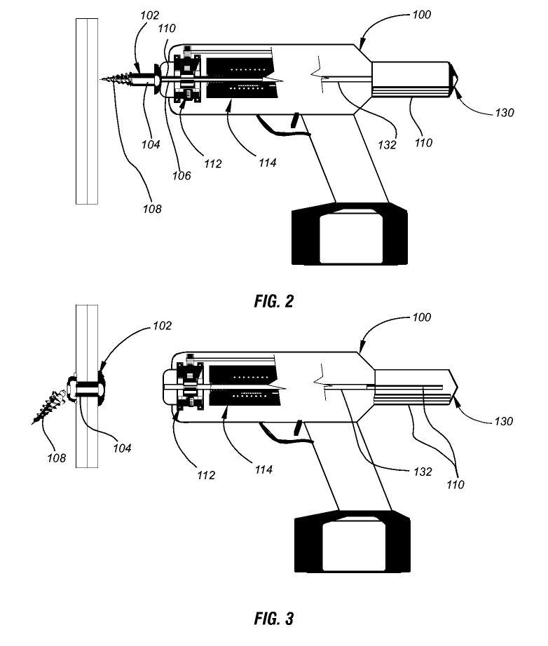

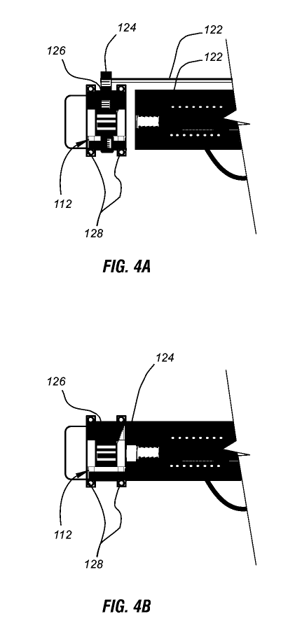

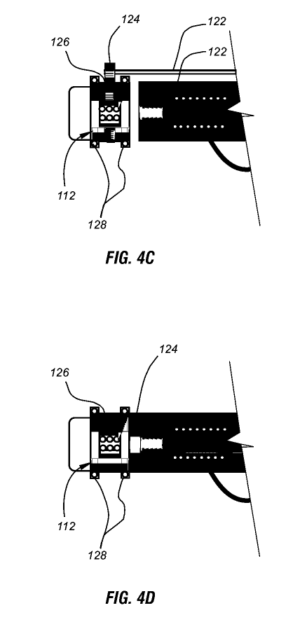

The rivet setting device 100 includes a rotatable head 112 for rotating the shank 110 and the self-tapping head 108 of the mandrel 106 to form the hole in the work piece, and a shank retracting assembly 114 for retracting the mandrel 106 rearward relative to the hollow rivet body 104. In one embodiment of the rivet setting device 100, shown in FIGS. 2, 3 4A, and 4C, the rotatable head 112 and the shank retracting assembly 114 may be rotationally independent without departing from the scope and intent of the present invention. For instance, the shank retracting assembly 114 may remain stationary while the rotatable head 112 rotates, or the like. Alternatively, as shown in FIGS. 4B and 4D, the rotatable head 112 and the shank retracting assembly may be fixedly connected, rotating in concert. Additionally, it is contemplated that an auto feeder for supplying a plurality of self-tapping rivets 102 in succession may be added to the rivet setting device 100 without departing from the scope of the present invention.

Preferably, the rotatable head 112 stops rotating when the self-tapping head 108 of the mandrel 106 fully exits the work piece, in preparation for the action of the shank retracting assembly 114, which compresses and spreads the hollow rivet body 104 by retracting the shank 110 rearward relative to the hollow rivet body 104. For example, the rivet setting device 100 may sense a reduction in torque when the self-tapping head 108 fully exits the work piece, as the self-tapping head 108 will rotate with substantially less resistance when it is not cutting through the work piece. Alternately, a double indent trigger, a system of separate triggers, or the like may be used to control when the rotatable head 112 stops rotating and the shank retracting assembly 114 is activated. For instance, a trigger including a first indent position and a second indent position may be used; the first indent position causing rotation of the rotatable head 112 and the second trigger position causing the rotatable head 112 to stop rotating and activating the shank retracting assembly 114. Those of ordinary skill in the art will appreciate that many different trigger mechanisms and combinations may be used to control the rotation and timing of the rotatable head 112 and the shank retracting assembly 114 without departing from the scope and spirit of the present invention.

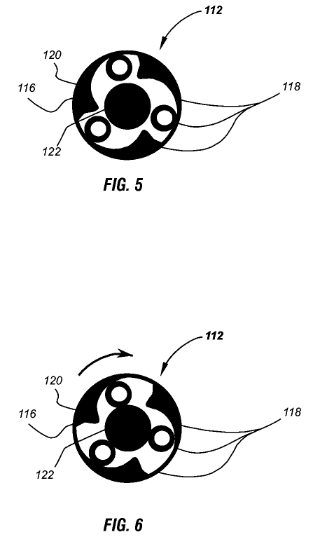

In exemplary embodiments of the present invention, the rotatable head 112 includes a clutch comprising a clutch body 116 enclosing a plurality of notched, tubular bearings 118 circumferentially located around the shank 110 of the mandrel 106, for gripping the shank 110 as shown in FIGS. 5 and 6. The clutch body 116 is formed with a plurality of tapered channels 120 for forcing the bearings 118 into engagement with the shank 110 upon rotation of the clutch 116. The tapered channels 120 narrow from a larger cross-sectional area to a smaller cross-sectional area counter to a direction of rotation of the rotatable head 112 for engaging the bearings 118 with the shank 110. Thus, the bearings 118 grip the shank 110 and rotate the self-tapping head 108 for cutting through the work piece when the rotatable head 112 is rotated in the direction for engaging the bearings 118 with the shank 110. While the shank 110 of the mandrel 106 is shown with a circular cross-sectional profile in the accompanying figures, it is contemplated that a shank having a multi-faceted cross-sectional profile, such as hexagonal, octagonal, or the like, may also be used with the rivet setting device 100 of the present invention. Those of ordinary skill in the art will further appreciate that the clutch body 116, the bearings 118, and the tapered channels 120 may be sized and configured for gripping shanks 110 having different sizes, cross-sectional profiles, or the like. For example, the clutch body 116, the bearings 118, and the tapered channels 120 may be sized and configured for gripping shanks 110 ranging from one eighth inch to one-quarter inch in diameter.

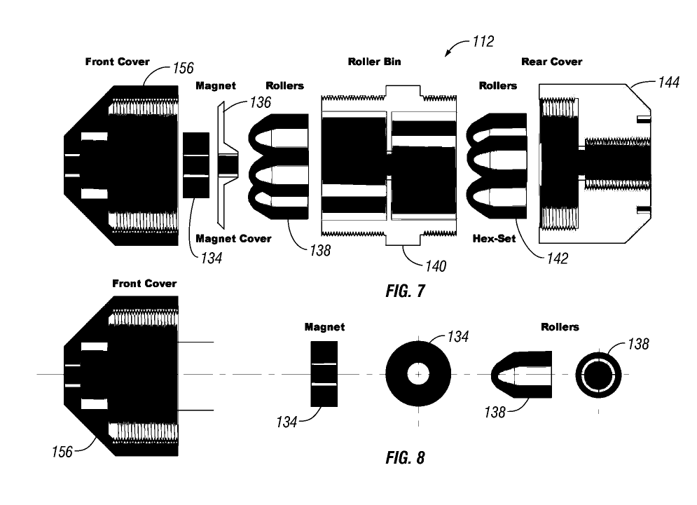

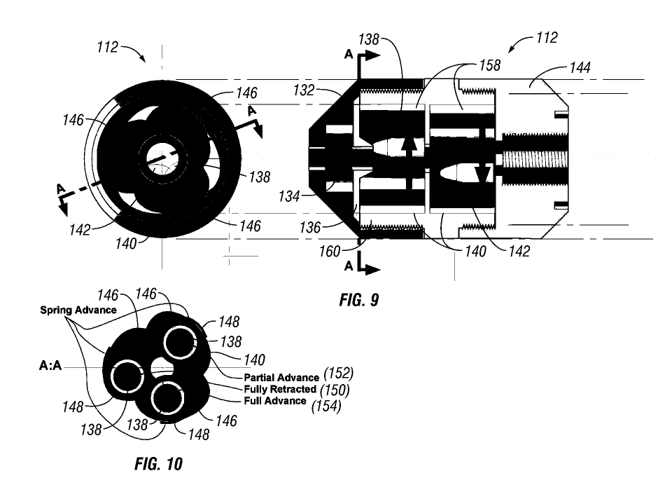

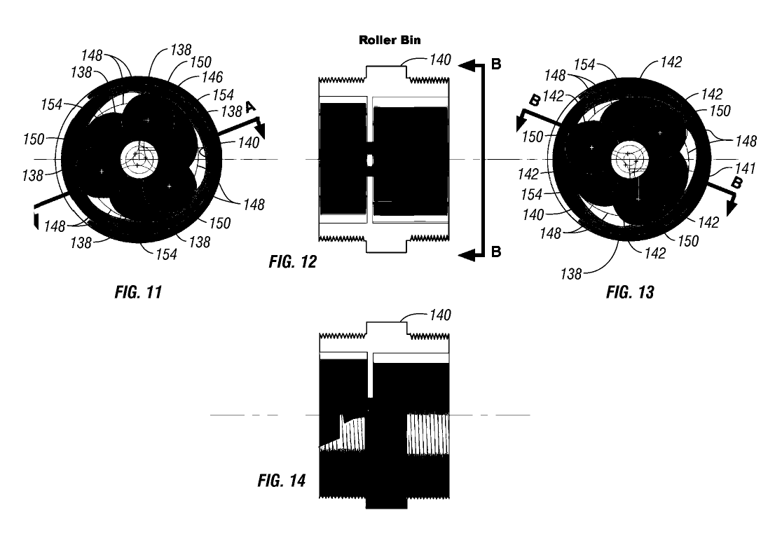

In another exemplary embodiment of the present invention, FIGS. 7-14 illustrate a rotatable head 112 having a front cover 156, a back cover 144 adapted to attach to roller bin 140. Roller bin 140 encloses rollers 138 and 142. A magnet 134 and magnet cover 136 are positioned between the front cover 156 and the roller bin 140. Those skilled in the art would appreciate that a dust restraint or grommet, rubber or otherwise, could be used in place of the magnet 134. Each cylindrical roller 138 and 142 has one dome shaped end, for allowing ease of insertion and loading of self-tapping rivet 102 into the rivet setting device 100. Further, FIG. 9 which is a cross-sectional front elevation view and cross-sectional side elevation view of the clutch 158 and tapered channels 146, wherein the clutch 158 is in a rotational position for engaging bearing 138 and 142 with the shank for rotating the shank. The clutch 158 is formed within the clutch body 160. FIG. 10 shows the rollers 138 adjacent the tapered channels 146 in a fully retracted position 150, partially advanced position 152 and fully advanced position 154. Each roller 138 is urged from the fully retracted position 150 to the fully advanced position 154 by spring 148. FIGS. 11 and 13 show the movement of bearings 138 and 142, respectively. Bearings 138 and 142 are configured such that bearings 138 engage the shank when the rotatable head 112 is rotated one way, and bearings 142 engage the shank when the rotatable head 112 is rotated the opposite way. Furthermore, when bearings 138 engage the shank, bearings 142 disengage the shank and visa versa. For example, FIG. 11 shows the movement of each bearing 138 from the fully retracted position 150 to the fully advanced position 154 when the rotatable head 112 is rotated in one direction. FIG. 13 also shows the position of bearings 142 when the head is rotated in the same direction, where bearings 142 move from the fully advanced position 154 to the fully retracted position 150, opposite the movement of bearings 138 (shown in FIG. 11). In both cases, tapered channels 146 control the circumferential and radial inward and outward movement of rollers 138 and 142. In operation, rotatable head 112 may be rotated one direction which would cause rollers 138 to move from the fully retracted position 152 to the fully advanced position 154 thereby making contact with the shank to rotate the shank for creating a hole in the work piece using the self-tapping head 108. Reversing the direction of the rotatable head 112 would then cause rollers 138 to disengage the shank while rollers 142 move from the fully retracted position 150 to the fully advanced position 154 to engage the shank and activate the shank retracting assembly to set the rivet in the work pieces and detach the shank from the rivet. Depending on the desired movement of the individual rollers 138 and 142, the roller bin 140 could take on various configurations as shown in FIGS. 12 and 14. Once the shank is separated from the rivet, the separated shank may be spring ejected from the rotatable head 112 through ejection passage 166 into a shank collection assembly 130 as shown in FIG. 3.

Those of ordinary skill in the art will appreciate that many different types and is varieties of clutches may be used without departing from the scope and spirit of the present invention. For instance, as shown in FIGS. 4C and 4D, the bearings 118 may be formed as ball bearings or the like, for allowing ease of insertion and loading of a self-tapping rivet 102 into the rivet setting device 100; however, in many applications, the notched, tubular bearings 118 shown in FIGS. 2, 3,4A and 4B may be preferable for increased surface area contact and gripping force. For this reason, it is contemplated that the bearings 118 may be formed as ball bearings in combination with an annular taper formed in the shank 110 for engaging with the bearings 118, such as a Morse taper or the like. Such an annular taper may prevent rotation of the shank 110 relative to the bearings 118 when the rotatable head 112 is rotated in the direction for engaging the bearings 118 with the shank 110. It should be noted that the annular taper may correspond with the area of reduced diameter for allowing the self-tapping head 108 to detach from the shank 110 upon application of the predetermined tensile force, as previously mentioned. Those of ordinary skill in the art will further appreciate that the clutch 116 may be reversible, operating as a right handed clutch or a left-handed clutch, depending on the orientation of the tapered channels 120.

In the exemplary embodiment of the rivet setting device 100 shown in the accompanying figures, the rotatable head 112 is rotated by an output drive shaft 122, driven by an electrical motor, a pneumatic drive system, a gas-powered engine, or the like. The output drive shaft 122 includes a gear 124 enmeshed with gear teeth 126 located circumferentially about the rotatable head 112. Preferably, the rotatable head 112 is seated in a plurality of bearings, such as ball bearings 128 or the like, for allowing smooth and efficient rotation of the rotatable head 112 as it is driven by the output drive shaft 122. Those of ordinary skill in the art will appreciate that the rotatable head 112 may be driven in a variety of different ways, however. For instance, it is contemplated that a rotatable head fixedly connected to the shank retracting assembly 114 may be driven by rotating the shank retracting assembly 114.

Preferably, when the rotatable head 112 stops rotating, the absence of rotational force applied to the bearings 118 enables the release of the bearings 118 from engagement with the shank 110, in preparation for the action of the shank retracting assembly 114, which compresses and spreads the hollow rivet body 104 by retracting the shank 110 rearward relative to the hollow rivet body 104. However, it is contemplated that an opposite rotational force may be required to release the bearings 118 from engagement with the shank 110. It is contemplated that the opposite rotational force may be applied to the clutch 116 in a number of different ways. For instance, the output drive shaft 122 may be driven in an opposite rotational direction to apply an opposite rotational force to the clutch 116, for releasing the bearings 118 from engagement with the shank 110. Those of ordinary skill in the art will appreciate that the opposite rotational force may be applied to the clutch 116 in many different ways without departing from the scope and intent of the present invention.

In exemplary embodiments of the present invention, the rivet setting device 100 includes a shank collection assembly 130, generally in-line with the shank retracting assembly 114, for collecting discarded shanks 110 after each shank 110 is separated from its corresponding self-tapping head 108. The shank collection assembly 130 is connected with the shank retracting assembly 114 by an ejection passage 132, permitting separated shanks 110 to be conveyed from the shank retracting assembly 114 to the shank collection assembly 130 by a spring ejection force, or the like. Those of ordinary skill in the art will appreciate that the shank collection assembly 130 may be formed or constructed in a variety of ways, including being sized appropriately for receiving a typical number of shanks which may be discarded in the course of a typical work period. Preferably, the shank collection assembly 130 is easily removed from the rivet setting device 100 for the removal of the collected shanks 110. It should be noted that it may be desirable to include a safety mechanism for preventing operation of the rivet setting device 100 while the shank collection assembly 130 is separated from the rivet setting device 100, or the like. One skilled in the art would appreciate that where the ejection passage 132 passes through the motor, the motor could be adapted to have a hollow armature. Alternatively, the ejection passage 132 could be rerouted such that the hollow armature in the motor is not required.

It is believed that the present invention and many of its attendant advantages will be understood by the foregoing description, and it will be apparent that various changes may be made in the form, construction and arrangement of the components thereof without departing from the scope and spirit of the invention or without sacrificing all of its material advantages.

What is claimed is:

1. A rivet setting tool for use with a self-tapping rivet having a mandrel with a shank and a self-tapping head, a weakened area of reduced diameter and a hollow rivet body surrounding the mandrel for joining one or more work pieces, the rivet setting tool comprises:
a tool body;
a rotatable head adapted to grip and rotate the shank of the self-tapping rivet with respect to the tool body; and
a shank retracting assembly adapted to operate in concert with the rotatable head to thereby compress and spread the hollow body with the head and detach the shank from the head.

2. The rivet setting tool of claim 1 wherein the rotatable head and the shank retracting assembly are rotationally independent from each other.

3. The rivet setting tool of claim 1 further comprises an auto feeder assembly to thereby automatically supply and communicate a plurality of the self-tapping rivets in succession to the rotatable head.

4. The rivet setting tool of claim 1 further comprises a torque sensor to stop rotation of the rotatable head and activate the shank retracting assembly when the self-tapping head cuts through the work pieces.

5. The rivet setting tool of claim 1 further comprises an output drive shaft rotating the rotatable head.

6. The rivet setting tool of claim 5 wherein the output drive shaft is electrically, pneumatically or combustion driven.

7. The rivet setting tool of claim 6 wherein the output drive shaft further comprises a gear for enmeshing with gear teeth positioned circumferentially about the rotatable head.

8. The rivet setting tool of claim 1 further comprises a plurality of bearings for rotatably supporting the rotatable head.

9. The rivet setting tool of claim 1 wherein separated shanks are conveyed by a spring ejection force to a shank collection assembly through an ejection passage.

10. A rivet setting tool for setting a self-tapping rivet in one or more work pieces, the rivet setting tool comprises:
a tool body;
a rotatable head having a clutch with a clutch body and a plurality of tapered channels enclosing and urging a plurality of bearings into gripping contact with a shank of the self-tapping rivet for rotating the self-tapping rivet with respect to the tool body; and
a shank retracting assembly adapted to pull on the shank to set the self-tapping rivet in the work pieces and detach the shank from the self-tapping rivet.

11. The rivet setting tool of claim 10 wherein the plurality of tapered channels decrease in cross-sectional area opposite the direction of rotation the rotatable head moves to bring the plurality of bearings into contact with the shank of the self-tapping rivet.

12. The rivet setting tool of claim 10 wherein the plurality of bearings are a plurality of notched tubular bearings positioned circumferentially adjacent the plurality of tapered channels.

13. The rivet setting tool of claim 10 wherein the plurality of bearings are a plurality of cylindrical rollers positioned circumferentially adjacent the plurality of tapered channels.

14. The rivet setting tool of claim 13 wherein the plurality of cylindrical rollers each include one dome-shaped end to thereby ease insertion of the shank into the clutch.

15. The rivet setting tool of claim 10 wherein the clutch body, plurality of tapered channels and plurality of bearings are sized to grip various size and shape shanks.

16. The rivet setting tool of claim 10 wherein the tool body has a gripping portion.

17. A method for setting a self-tapping rivet in one or more work pieces with a rivet setting tool, the method comprising:
gripping the rivet setting tool;
inserting a shank of the self-tapping rivet into a rotatable head having a clutch enclosing a plurality of bearings;
rotating the rotatable head for moving the plurality of bearings with a plurality of tapered channels into contact with the shank to grip the shank;
turning the shank with the rotatable head for moving the self-tapping rivet through the work pieces; and
retracting a shank retracting assembly for setting the self-tapping rivet in the work pieces and detaching the shank from the self-tapping rivet.

18. The method of claim 17 further comprising the step of moving a trigger to a first position for activating the rotatable head and a second position for activating the shank retracting assembly.

19. The method of claim 17 further comprising the step of turning the rotatable head one direction for gripping the shank with the rotatable head and the opposite direction for simultaneously releasing grip of the shank with the rotatable head while gripping the shank with the shank retracting assembly.

20. The method of claim 17 further comprising the step of ejecting the detached shanks into a shank collection assembly detachably mounted to the rivet setting tool.

21. A method for setting a self-tapping rivet in one or more workpieces with a rivet setting tool, the method comprising:
providing a tool body with a rotatable head having a clutch with a clutch body and a plurality of taper channels enclosing a plurality of bearings and a shank retracting assembly adapted to operate in concert with the rotatable head;
gripping the tool body of the rivet setting tool;
inserting a shank of the self-tapping rivet into the rotatable head;
rotating the rotatable head for moving the plurality of bearings with the plurality of taper channels into contact with the shank to grip the shank;
turning the shank with the rotatable head for moving the self-tapping rivet through the workpieces; and
retracting the shank retracting assembly for setting the self-tapping rivet in the workpieces and detaching the shank from the self-tapping rivet.
